(19) United States
(12) Patent Application Publication
(10) Pub. No.: US 2013/0339467 A1
(43) Pub. Date: Dec. 19, 2013

(54) Wireless Mobile Data Server With Removable Solid-State Memory

(71) Applicants: Steven B. Volk, Boulder, CO (US); Wendy T. Volan, Longmont, CO (US); Gregory Dimitri Volan, Longmont, CO (US); Dagan X. Packman, Longmont, CO (US)

(72) Inventors: Steven B. Volk, Boulder, CO (US); Wendy T. Volan, Longmont, CO (US); Gregory Dimitri Volan, Longmont, CO (US); Dagan X. Packman, Longmont, CO (US)

(73) Assignee: VMO SYSTEMS INC., Boulder, CO (US)

(21) Appl. No.: 13/915,756

(22) Filed: Jun. 12, 2013

Related U.S. Application Data
(60) Provisional application No. 61/659,725, filed on Jun. 14, 2012.

(51) Int. Cl. G06F 15/167

(52) U.S. Cl. CPC G06F 15/167
USPC 709/212

(57) ABSTRACT

A battery operated, wireless mobile data server with an application processing environment and a relational database management system and removable solid-state memory for the distribution and recording of content accessible from clients consisting of multiple mobile devices such as smartphones, tablet computers, notebook computers and other mobile computing devices. The mobile data server can perform processing of application code and perform queries on relational databases and wirelessly provide access to large data sets independently to multiple mobile devices or in coordination to multiple mobile devices, irrespective of the mobile devices' operating systems within a defined geographic range without the use of a cellular infrastructure.

### CROSS-REFERENCE TO RELATED APPLICATION

This application claims the priority of provisional Application No. 61/659,725, filed Jun. 14, 2012, which is incorporated herein by reference in its entirety.

### BACKGROUND OF THE INVENTION

1. Field of the Invention

The invention relates in general to a method of distributing and recording content via a mobile data server with application processing and relational database management capability for mobile devices with dissimilar operating systems without the use of cellular infrastructure. The method utilizes a unique solid-state memory module consisting of flash memory chips and a controller or SD or microSD cards that can be rapidly replicated with content and designed with multiple capacity points with read/write or read only capability.

2. Description of the Related Art

As mobile devices such as smartphones and tablet computers proliferate, there is a requirement for distributing, recording, processing and querying large data sets wirelessly for mobile workers, military and defense personnel and law enforcement without the dependency on a cellular infrastructure. Often times, in the case of military operations. natural disasters, field data collection or remote workers, cellular networks do not exist, are not capable of transmitting and receiving large data sets or do not have the required level of security.

### SUMMARY OF THE INVENTION

A battery operated, wireless mobile data server with an application processing environment and a relational database management system and removable solid-state memory for the distribution and recording, of content accessible from clients consisting of multiple mobile devices such as smartphones, tablet computers, notebook computers and other mobile computing devices. The mobile data server can perform processing of application code and perform queries on relational databases and wirelessly provide access to large data sets independently to multiple mobile devices or in coordination to multiple mobile devices, irrespective of the mobile devices operating systems within a defined geographic range without the use of a cellular infrastructure.

### BRIEF DESCRIPTION OF THE DRAWINGS

FIG. 1A shows the mobile data server device.

FIG. 1B is an exploded view of the mobile data server device and the memory module.

FIG. 2 is an exploded view of the memory module.

FIG. 3 is a block diagram of the mobile data server electronics.

FIG. 4 is a block diagram of the application processing and relational database management system firmware.

### DETAILED DESCRIPTION OF THE INVENTION

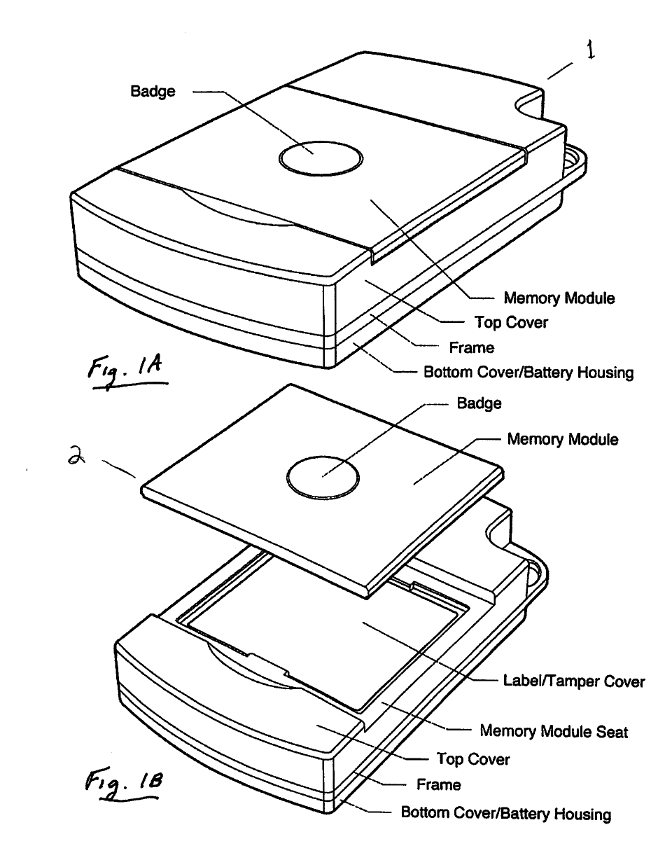

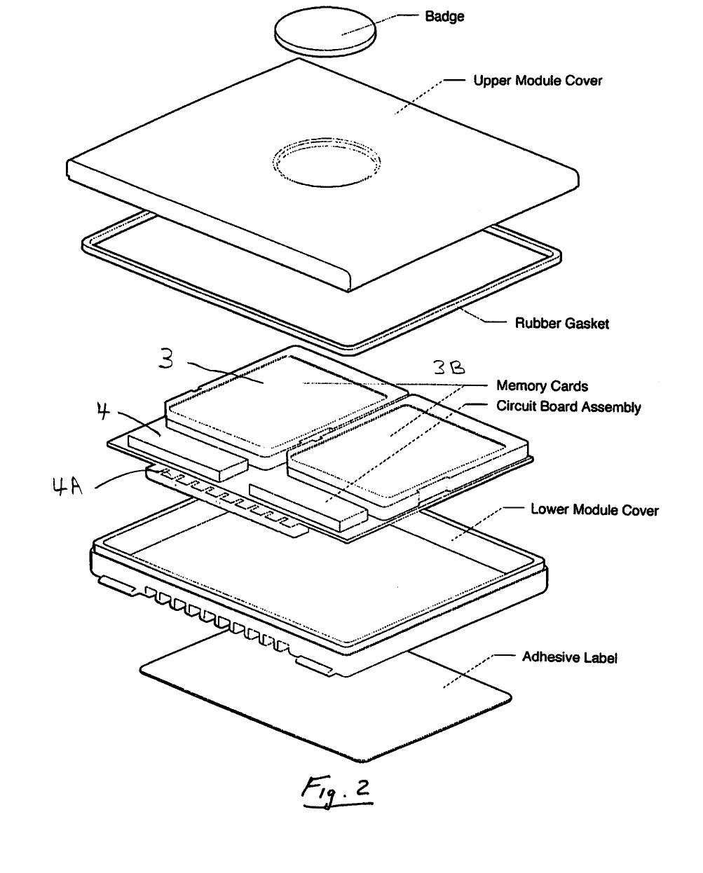

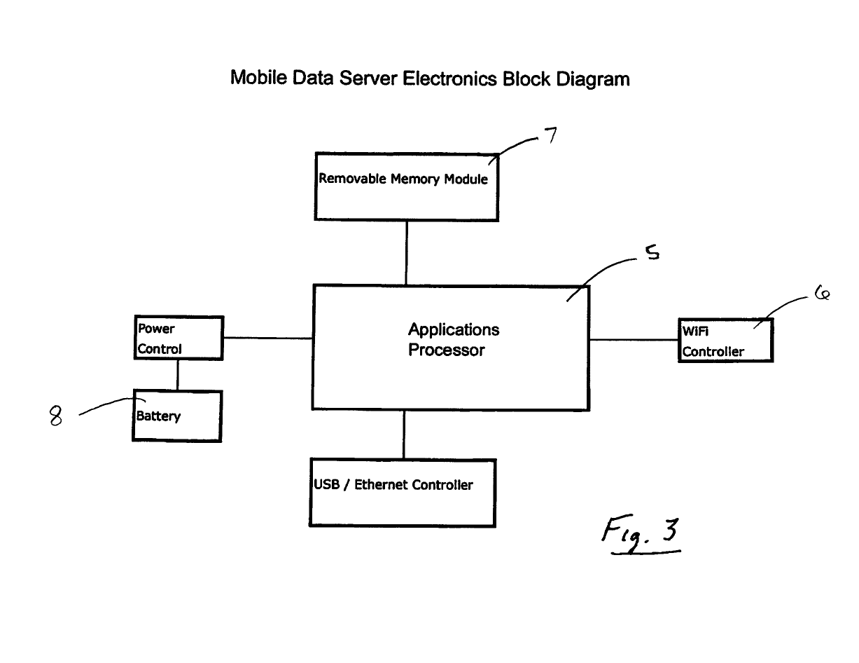

FIG. 1A shows battery operated, wireless mobile data server 1 with an application processing environment 5 and a relational database management system 10 and removable solid-state memory 7 for the distribution and recording of content accessible from clients consisting of multiple mobile devices such as smartphones, tablet computers, notebook computers and other mobile computing devices. The mobile data server 1 can perform processing, of application code 5 and perform queries on relational databases 10 and wirelessly 6 provide access to large data sets independently to multiple mobile devices 9 or in coordination to multiple mobile devices, irrespective of the mobile devices' operating systems within a defined geographic range without the use of a cellular infrastructure. Solid-state memory modules 2 can be configured with various data capacities, pre-recorded with application code, relational databases. GIS data sets and other large data sets for content distribution, constructed to he read-only or writable in a format for high performance reading and writing. Content can be encrypted and mass replicated on the solid-state memory modules 2 for distribution to mobile data servers 1 in the field. Applications on client devices such as smartphones, tablet computers and notebook computers can decode and decrypt content sent wirelessly 6 from the mobile data server 1 and encode and encrypt content sent wirelessly 6 to the mobile data server 1. FIG. 2 shows solid-state memory module 2 consists of flash memory chips 3 and a controller 4, or SD or microSD cards 3B encapsulated in a compact module 2.

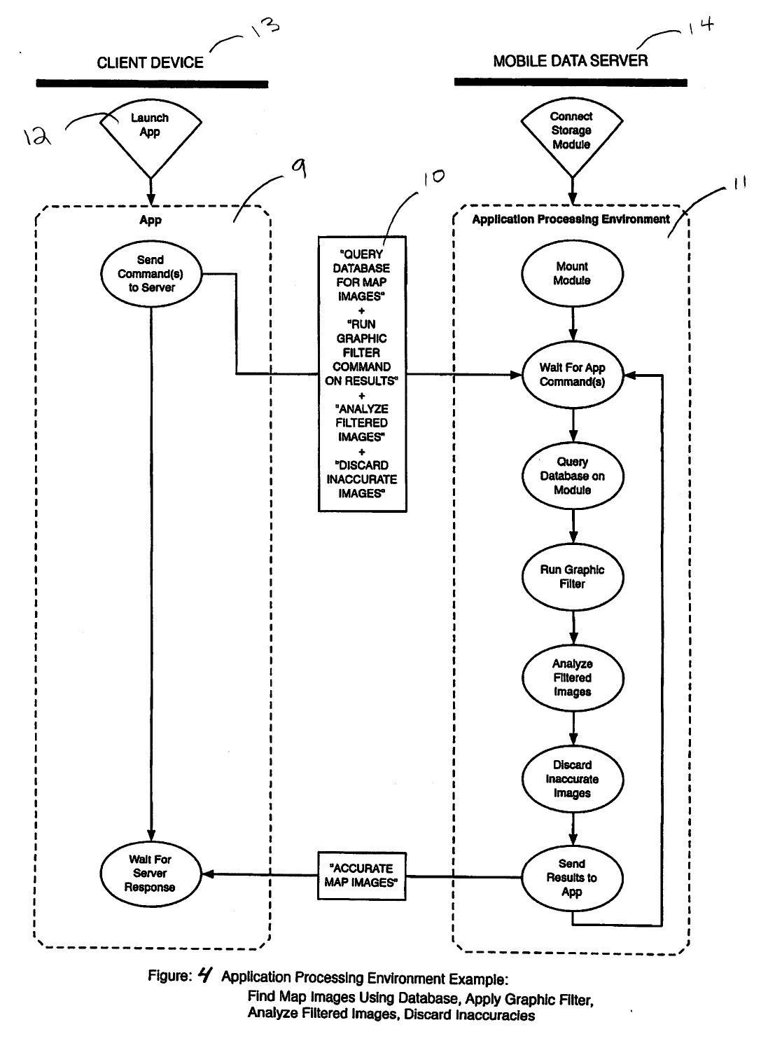

In an embodiment, a battery operated mobile data server 1 is provided that accepts a removable solid-state memory module 2 of various capacities that is read only. The battery 8 operated mobile data server 1 has a high-speed wireless data interface 4A coupled to the removable solid-state read only memory module 2. An application 12 resides on mobile client devices 9 such as smartphones, tablet computers or notebook computers that connects to the mobile data server 1 and optionally decodes and decrypts data sent by the data server 1. At the request of the client device 13, the mobile data server 14 can process application 5 code stored on the removable solid-state memory module 7. FIG. 4 shows that the application code 11 can instruct the mobile data server 14 to perform queries 10 using the mobile data server relational database management system 10 on relational databases stored on the removable solid-state memory module 7. The data sets resulting from those queries can be further processed by the mobile data server using additional instructions provided in the application code 10 and further processed by the mobile data server using additional instructions provided by the client device 13. Whether further processed or not, the queried data 10 is then delivered to an individual or multiple client devices 13. The mobile data server 14 can process multiple requests from multiple clients 13 with dissimilar operating systems simultaneously and provide an independent response to each client or a single response to multiple clients, depending on the instructions included in the application code or the instructions sent by the client 13.

In another embodiment, the removable solid-state memory module 2 is recordable and data from multiple client devices 13 can he wirelessly 6 sent to the mobile data server 14 and be recorded on the memory module 2 in various data formats, including relational databases shown in 10.

In another embodiment, the removable solid-state memory module 2 contains one or more SD or microSD cards 3B.

What is claimed is:

1. A battery operated mobile data server capable of transmitting and receiving data to and from multiple mobile devices such as smartphones, tablet computers, netbooks and notebook computers using dissimilar operating systems.

2. An application code processing environment resident in hardware or firmware or hardware and firmware of a battery operated mobile data server that is capable of querying data, editing data, analyzing data, calculating data, distributing data to connected mobile devices, retrieving data resident on the solid-state memory module and writing data to the solid-state memory module.

3. A battery operated mobile data server capable of processing application code resident on the solid-state memory module and transmitting the results of that processed code to multiple mobile devices simultaneously with dissimilar operating systems, independent of any other mobile devices connected to the mobile data server.
